(19) United States
(12) Patent Application Publication
(10) Pub. No.: US 2016/0070791 A1
(43) Pub. Date: Mar. 10, 2016

(54) Generating Search Engine-Optimized Media Question and Answer Web Pages

(71) Applicant: Chegg, Inc., Santa Clara, CA (US)

(72) Inventors: Marc Eberhart, Santa Clara, CA (US); Andrew Nicholas Smolik, Santa Clara, CA (US); Ankit Garg, Santa Clara, CA (US); Charmy Chhichhia, Santa Clara, CA (US)

(21) Appl. No.: 14/479,046

(22) Filed: Sep. 5, 2014

(51) Int. Cl. G06F 17/30

(52) U.S. Cl. CPC G06F 17/30864

(57) ABSTRACT

An online system generates web pages for user-generated questions that are structured to rank highly in search results generated by external search engines. The online system receives a question uploaded to the online system by a user. The question includes media content, such as an image, a voice recording, or a video. The online system transcribes the media content of the question and applies a web page template to the question content to generate a web page. The template includes a metadata description, a breadcrumb, and a uniform resource locator. At least one of the metadata description, breadcrumb, and uniform resource locator comprises a portion of the transcribed media content of the question. The online system publishes the web page at a location specified by the uniform resource locator.

### BACKGROUND

1. Field of the Invention

This disclosure relates to generating search engine-optimized web pages for questions uploaded to an education platform.

2. Description of the Related Art

Education platforms provide students with access to a wide range of collaborative tools and solutions that are rapidly changing the way courses are taught and delivered. As traditional courses are shifting from a static textbook-centric model to a connected one where related, personalized, and other social-based content activities are being aggregated dynamically within the core academic material, it becomes strategic for education publishing platforms to be able to process and optimize the discoverability and ranking of the platform's content on external search engines. In particular, it is advantageous for an education publishing platform to make questions asked by registered users of the platform discoverable to users who are not registered to the platform to increase visibility of the education publishing platform.

However, dynamically-generated content web pages, such as web pages for questions asked by users, are typically not ranked highly in search results generated by external search engines. As search engine users typically select top-ranked search results and ignore lower-ranked search results, a lower ranking of the question web pages results in lost opportunities to drive traffic to the education platform and lost revenue for the education platform.

### SUMMARY

An education platform receives questions uploaded by registered users of the platform and answers to the questions. The questions uploaded to the platform may include media content, such as an image, a voice recording, or a video. For a question uploaded to the education platform, the education platform transcribes the media content of the question and applies a template to the question to generate a web page for the question. The template may generate one or more of a title, URL, breadcrumb, category, metadata description, and metadata keywords for the web page that are structured to increase the ranking of the web page at an external search engine. One or more of the title, URL, breadcrumb, metadata description, and metadata keywords includes a portion of the transcribed media content of a question. The breadcrumb and category may further include a classification of the question in a subject matter taxonomy of the education platform.

By increasing the ranking of a question web page in search results generated by an external web search engine, the education platform improves discoverability of the questions. Users who are not registered to the education platform may visit the question web pages because of their high ranking at an external search engine, which drives visitation to the web pages of the education platform, which in turn may ultimately increase revenue of the education platform.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 illustrates an example education platform, according to one embodiment.

FIG. 2 is a block diagram illustrating interactions with an education platform, according to one embodiment.

FIG. 3 illustrates a document reconstruction process, according to one embodiment.

FIG. 4 illustrates an education publishing platform, according to one embodiment.

FIG. 5 is a flowchart illustrating a process for generating a search engine-optimized question and answer web page, according to one embodiment.

FIGS. 6A-6B illustrate example questions uploaded to an education publishing platform.

FIG. 7 illustrates an example answer uploaded to an education publishing platform.

FIG. 8 illustrates an example search engine-optimized question web page.

FIG. 9 illustrates example search results listing search engine-optimized question web pages.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Embodiments described herein provide for generating search engine-optimized web pages for questions including media content. One example online system managing questions and answers uploaded by users is an education publishing platform configured for digital content interactive services distribution and consumption. In the platform, personalized learning services are paired with secured distribution and analytics systems for reporting on both connected user activities and effectiveness of deployed services. The education platform manages educational services through the organization, distribution, and analysis of electronic documents.

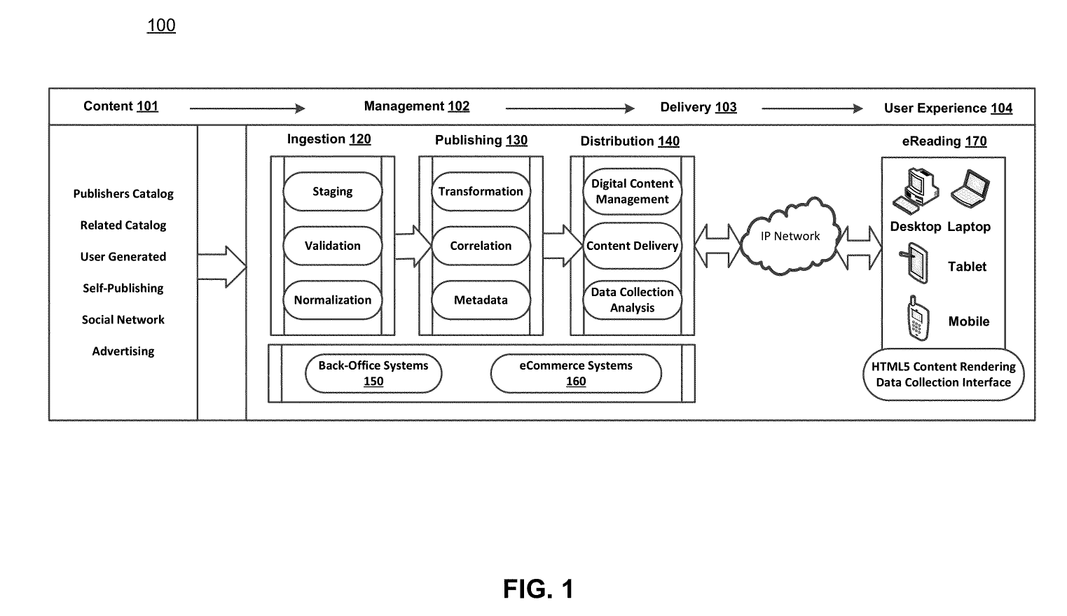

FIG. 1 is a high-level block diagram illustrating the education platform environment 100. The education platform environment 100 is organized around four function blocks: content 101, management 102, delivery 103, and experience 104.

Content block 101 automatically gathers and aggregates content from a large number of sources, categories, and partners. Whether the content is curated, perishable, on-line, or personal, these systems define the interfaces and processes to automatically collect various content sources into a formalized staging environment.

Management block 102 comprises five blocks with respective submodules: ingestion 120, publishing 130, distribution 140, back office system 150, and eCommerce system 160. The ingestion module 120, including staging, validation, and normalization subsystems, ingests published documents that may be in a variety of different formats, such as PDF, ePUB2, ePUB3, SVG, XML, or HTML. The ingested document may be a book (such as a textbook), a set of self-published notes, or any other published document, and may be subdivided in any manner. For example, the document may have a plurality of pages organized into chapters, which could be further divided into one or more sub-chapters. Each page may have text, images, tables, graphs, or other items distributed across the page.

After ingestion, the documents are passed to the publishing system 130, which in one embodiment includes transformation, correlation, and metadata subsystems. If the document ingested by the ingestion module 120 is not in a markup language format, the publishing system 130 automatically identifies, extracts, and indexes all the key elements and composition of the document to reconstruct it into a modern, flexible, and interactive HTML5 format. The ingested documents are converted into markup language documents well-suited for distribution across various computing devices. In one embodiment, the publishing system 130 reconstructs published documents so as to accommodate dynamic add-ons, such as user-generated and related content, while maintaining page fidelity to the original document. The transformed content preserves the original page structure including pagination, number of columns and arrangement of paragraphs, placement and appearance of graphics, titles and captions, and fonts used, regardless of the original format of the source content and complexity of the layout of the original document.

The page structure information is assembled into a document-specific table of contents describing locations of chapter headings and sub-chapter headings within the reconstructed document, as well as locations of content within each heading. During reconstruction, document metadata describing a product description, pricing, and terms (e.g., whether the content is for sale, rent, or subscription, or whether it is accessible for a certain time period or geographic region, etc.) are also added to the reconstructed document.

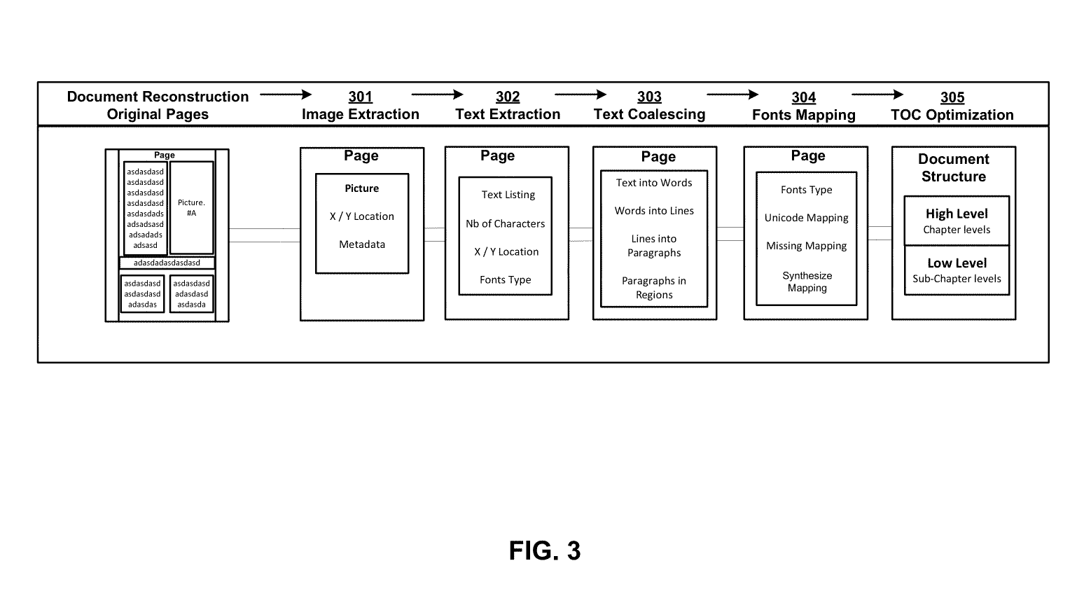

The reconstructed document's table of contents indexes the content of the document into a description of the overall structure of the document, including chapter headings and sub-chapter headings. Within each heading, the table of contents identifies the structure of each page. As content is added dynamically to the reconstructed document, the content is indexed and added to the table of contents to maintain a current representation of the document's structure. The process performed by the publishing system 130 to reconstruct a document and generate a table of contents is described further with respect to FIG. 3.

The distribution system 140 packages content for delivery, uploads the content to content distribution networks, and makes the content available to end users based on the content's digital rights management policies. In one embodiment, the distribution system 140 includes digital content management, content delivery, and data collection and analysis subsystems.

Whether the ingested document is in a markup language document or is reconstructed by the publishing system 130, the distribution system 140 may aggregate additional content layers from numerous sources into the ingested or reconstructed document. These layers, including related content, advertising content, social content, and user-generated content, may be added to the document to create a dynamic, multilayered document. For example, related content may comprise material supplementing the foundation document, such as study guides, textbook solutions, self-testing material, solutions manuals, glossaries, or journal articles. Advertising content may be uploaded by advertisers or advertising agencies to the publishing platform, such that advertising content may be displayed with the document. Social content may be uploaded to the publishing platform by the user or by other nodes (e.g., classmates, teachers, authors, etc.) in the user's social graph. Examples of social content include interactions between users related to the document and content shared by members of the user's social graph. User-generated content includes annotations made by a user during an eReading session, such as highlighting or taking notes. In one embodiment, user-generated content may be self-published by a user and made available to other users as a related content layer associated with a document or as a standalone document.

As layers are added to the document, page information and metadata of the document are referenced by all layers to merge the multilayered document into a single reading experience. The publishing system 130 may also add information describing the supplemental layers to the reconstructed document's table of contents. Because the page-based document ingested into the management block 102 or the reconstructed document generated by the publishing system 130 is referenced by all associated content layers, the ingested or reconstructed document is referred to herein as a “foundation document,” while the “multilayered document” refers to a foundation document and the additional content layers associated with the foundation document.

The back-office system 150 of management block 102 enables business processes such as human resources tasks, sales and marketing, customer and client interactions, and technical support. The eCommerce system 160 interfaces with back office system 150, publishing 130, and distribution 140 to integrate marketing, selling, servicing, and receiving payment for digital products and services.

Delivery block 103 of an educational digital publication and reading platform distributes content for user consumption by, for example, pushing content to edge servers on a content delivery network. Experience block 104 manages user interaction with the publishing platform through browser application 170 by updating content, reporting users' reading and other educational activities to be recorded by the platform, and assessing network performance.

In the example illustrated in FIG. 1, the content distribution and protection system is interfaced directly between the distribution sub-system 140 and the browser application 170, essentially integrating the digital content management (DCM), content delivery network (CDN), delivery modules, and eReading data collection interface for capturing and serving all users' content requests. By having content served dynamically and mostly on-demand, the content distribution and protection system effectively authorizes the download of one page of content at a time through time-sensitive dedicated URLs which only stay valid for a limited time, for example a few minutes in one embodiment, all under control of the platform service provider.

### Platform Content Processing and Distribution

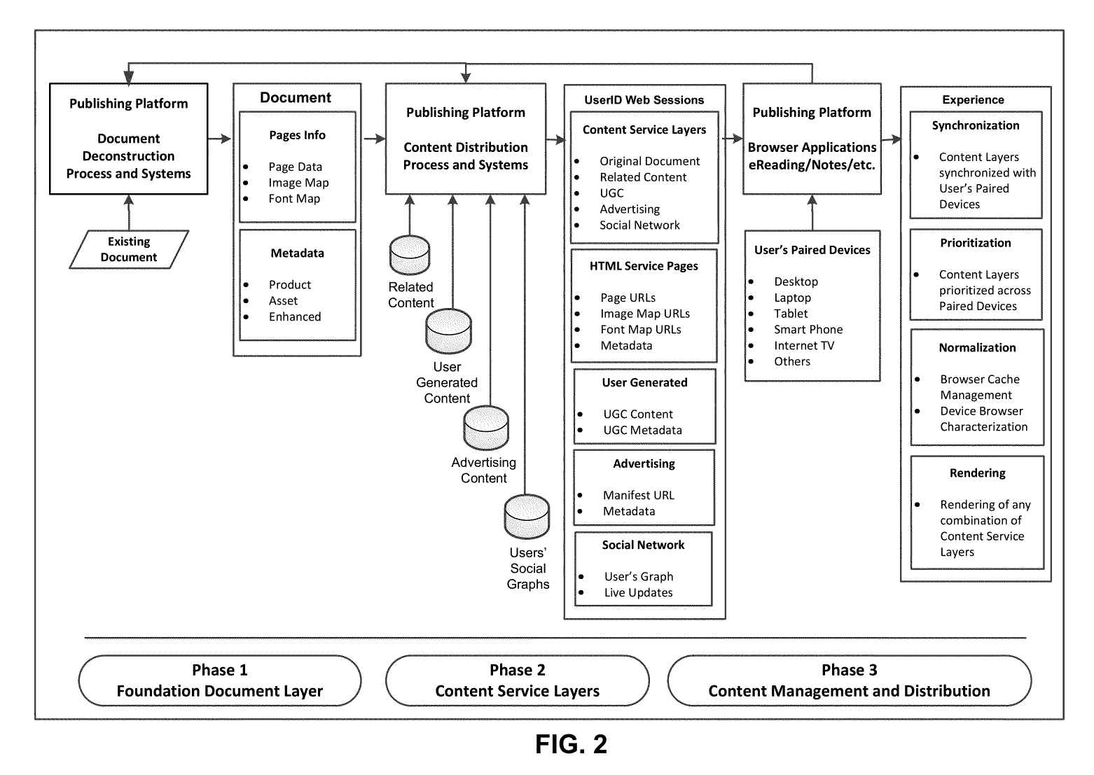

The platform content catalog is a mosaic of multiple content sources which are collectively processed and assembled into the overall content service offering. The content catalog is based upon multilayered publications that are created from reconstructed foundation documents augmented by supplemental content material resulting from users' activities and platform back-end processes. FIG. 2 illustrates an example of a publishing platform where multilayered content document services are assembled and distributed to desktop, mobile, tablet, and other connected devices. As illustrated in FIG. 2, the process is typically segmented into three phases: Phase 1: creation of the foundation document layer; Phase 2: association of the content service layers to the foundation document layer; and Phase 3: management and distribution of the content.

During Phase 1, the licensed document is ingested into the publishing platform and automatically reconstructed into a series of basic elements, while maintaining page fidelity to the original document structure. Document reconstruction will be described in more detail below with reference to FIG. 3.

During Phase 2, once a foundation document has been reconstructed and its various elements extracted, the publishing platform runs several processes to enhance the reconstructed document and transform it into a personalized multilayered content experience. For instance, several distinct processes are run to identify the related content to the reconstructed document, user generated content created by registered users accessing the reconstructed document, advertising or merchandising material that can be identified by the platform and indexed within the foundation document and its layers, and social network content resulting from registered users' activities. By having each of these processes focusing on specific classes of content and databases, the elements referenced within each classes become identified by their respective content layer. Specifically, all the related content page-based elements that are matched with a particular reconstructed document are classified as part of the related content layer. Similarly, all other document enhancement processes, including user generated, advertising and social among others, are classified by their specific content layer. The outcome of Phase 2 is a series of static and dynamic page-based content layers that are logically stacked on top of each other and which collectively enhance the reconstructed foundation document.

During Phase 3, once the various content layers have been identified and processed, the resulting multilayered documents are then published to the platform content catalog and pushed to the content servers and distribution network for distribution. By having multilayered content services served dynamically and on-demand through secured authenticated web sessions, the content distribution systems are effectively authorizing and directing the real-time download of page-based layered content services to a user's connected devices. These devices access the services through time sensitive dedicated URLs which, in one embodiment, only stay valid for a few minutes, all under control of the platform service provider. The browser-based applications are embedded, for example, into HTML5 compliant web browsers which control the fetching, requesting, synchronization, prioritization, normalization and rendering of all available content services.

### Document Reconstruction

The publishing system 130 receives original documents for reconstruction from the ingestion system 120 illustrated in FIG. 1. In one embodiment, a series of modules of the publishing system 130 are configured to perform the document reconstruction process.

FIG. 3 illustrates a process within the publishing system 130 for reconstructing a document. Embodiments are described herein with reference to an original document in the Portable Document Format (PDF) that is ingested into the publishing system 130. However, the format of the original document is not limited to PDF; other unstructured document formats can also be reconstructed into a markup language format by a similar process.

A PDF page contains one or more content streams, which include a sequence of objects, such as path objects, text objects, and external objects. A path object describes vector graphics made up of lines, rectangles, and curves. Path can be stroked or filled with colors and patterns as specified by the operators at the end of the path object. A text object comprises character stings identifying sequences of glyphs to be drawn on the page. The text object also specifies the encodings and fonts for the character strings. An external object XObject defines an outside resource, such as a raster image in JPEG format. An XObject of an image contains image properties and an associated stream of the image data.

During image extraction 301, graphical objects within a page are identified and their respective regions and bounding boxes are determined. For example, a path object in a PDF page may include multiple path construction operators that describe vector graphics made up of lines, rectangles, and curves. Metadata associated with each of the images in the document page is extracted, such as resolutions, positions, and captions of the images. Resolution of an image is often measured by horizontal and vertical pixel counts in the image; higher resolution means more image details. The image extraction process may extract the image in the original resolution as well as other resolutions targeting different eReading devices and applications. For example, a large XVGA image can be extracted and down sampled to QVGA size for a device with QVGA display. The position information of each image may also be determined. The position information of the images can be used to provide page fidelity when rendering the document pages in eReading browser applications, especially for complex documents containing multiple images per page. A caption associated with each image that defines the content of the image may also be extracted by searching for key words, such as “Picture”, “Image”, and “Tables”, from text around the image in the original page. The extracted image metadata for the page may be stored to the overall document metadata and indexed by the page number.

Image extraction 301 may also extract tables, comprising graphics (horizontal and vertical lines), text rows, and/or text columns. The lines forming the tables can be extracted and stored separately from the rows and columns of the text.

The image extraction process may be repeated for all the pages in the ingested document until all images in each page are identified and extracted. At the end of the process, an image map that includes all graphics, images, tables and other graphic elements of the document is generated for the eReading platform.

During text extraction 302, text and embedded fonts are extracted from the original document and the location of the text elements on each page are identified.

Text is extracted from the pages of the original document tagged as having text. The text extraction may be done at the individual character level, together with markers separating words, lines, and paragraphs. The extracted text characters and glyphs are represented by the Unicode character mapping determined for each. The position of each character is identified by its horizontal and vertical locations within a page. For example, if an original page is in A4 standard size, the location of a character on the page can be defined by its X and Y location relative to the A4 page dimensions. In one embodiment, text extraction is performed on a page-by-page basis. Embedded fonts may also be extracted from the original document, which are stored and referenced by client devices for rendering the text content.

The pages in the original document having text are tagged as having text. In one embodiment, all the pages with one or more text objects in the original document are tagged. Alternatively, only the pages without any embedded text are marked.

The output of text extraction 302, therefore, a dataset referenced by the page number, comprising the characters and glyphs in a Unicode character mapping with associated location information and embedded fonts used in the original document.

Text coalescing 303 coalesces the text characters previously extracted. In one embodiment, the extracted text characters are coalesced into words, words into lines, lines into paragraphs, and paragraphs into bounding boxes and regions. These steps leverage the known attributes about extracted text in each page, such as information on the text position within the page, text direction (e.g., left to right, or top to bottom), font type (e.g., Arial or Courier), font style (e.g., bold or italic), expected spacing between characters based on font type and style, and other graphics state parameters of the pages.

In one embodiment, text coalescence into words is performed based on spacing. The spacing between adjacent characters is analyzed and compared to the expected character spacing based on the known text direction, font type, style, and size, as well as other graphics state parameters, such as character-spacing and zoom level. Despite different rendering engines adopted by the browser applications 170, the average spacing between adjacent characters within a word is smaller than the spacing between adjacent words. For example, a string of “Berriesaregood” represents extracted characters without considering spacing information. Once taking the spacing into consideration, the same string becomes “Berries are good,” in which the average character spacing within a word is smaller than the spacing between words.

Additionally or alternatively, extracted text characters may be assembled into words based on semantics. For example, the string of “Berriesaregood” may be input to a semantic analysis tool, which matches the string to dictionary entries or Internet search terms, and outputs the longest match found within the string. The outcome of this process is a semantically meaningful string of “Berries are good.” In one embodiment, the same text is analyzed by both spacing and semantics, so that word grouping results may be verified and enhanced.

Words may be assembled into lines by determining an end point of each line of text. Based on the text direction, the horizontal spacing between words may be computed and averaged. The end point may have word spacing larger than the average spacing between words. For example, in a two-column page, the end of the line of the first column may be identified based on it having a spacing value much larger than the average word spacing within the column. On a single column page, the end of the line may be identified by the space after a word extending to the side of the page or bounding box.

After determining the end point of each line, lines may be assembled into paragraphs. Based on the text direction, the average vertical spacing between consecutive lines can be computed. The end of the paragraph may have a vertical spacing that is larger than the average. Additionally or alternatively, semantic analysis may be applied to relate syntactic structures of phrases and sentences, so that meaningful paragraphs can be formed.

The identified paragraphs may be assembled into bounding boxes or regions. In one embodiment, the paragraphs may be analyzed based on lexical rules associated with the corresponding language of the text. A semantic analyzer may be executed to identify punctuation at the beginning or end of a paragraph. For example, a paragraph may be expected to end with a period. If the end of a paragraph does not have a period, the paragraph may continue either on a next column or a next page. The syntactic structures of the paragraphs may be analyzed to determine the text flow from one paragraph to the next, and may combine two or more paragraphs based on the syntactic structure. If multiple combinations of the paragraphs are possible, reference may be made to an external lexical database, such as WORDNET®, to determine which paragraphs are semantically similar.

In fonts mapping 304, in one embodiment, a Unicode character mapping for each glyph in a document to be reconstructed is determined. The mapping ensures that no two glyphs are mapped to a same Unicode character. To achieve this goal, a set of rules is defined and followed, including applying the Unicode mapping found in the embedded font file; determining the Unicode mapping by looking up postscript character names in a standard table, such as a system TrueType font dictionary; and determining the Unicode mapping by looking for patterns, such as hex codes, postscript name variants, and ligature notations.

For those glyphs or symbols that cannot be mapped by following the above rules, pattern recognition techniques may be applied on the rendered font to identify Unicode characters. If pattern recognition is still unsuccessful, the unrecognized characters may be mapped into the private use area (PUA) of Unicode. In this case, the semantics of the characters are not identified, but the encoding uniqueness is guaranteed. As such, rendering ensures fidelity to the original document.

In table of contents optimization 305, content of the reconstructed document is indexed. In one embodiment, the indexed content is aggregated into a document-specific table of contents that describes the structure of the document at the page level. For example, when converting printed publications into electronic documents with preservation of page fidelity, it may be desirable to keep the digital page numbering consistent with the numbering of the original document pages.

The table of contents may be optimized at different levels of the table. At the primary level, the chapter headings within the original document, such as headings for a preface, chapter numbers, chapter titles, an appendix, and a glossary may be indexed. A chapter heading may be found based on the spacing between chapters. Alternatively, a chapter heading may be found based on the font face, including font type, style, weight, or size. For example, the headings may have a font face that is different from the font face used throughout the rest of the document. After identifying the headings, the number of the page on which each heading is located is retrieved.

At a secondary level, sub-chapter headings within the original document may be identified, such as dedications and acknowledgments, section titles, image captions, and table titles. Vertical spacing between sections, text, and/or font face may be used to segment each chapter. For example, each chapter may be parsed to identify all occurrences of the sub-chapter heading font face, and determine the page number associated with each identified sub-chapter heading.

### Education Publishing Platform

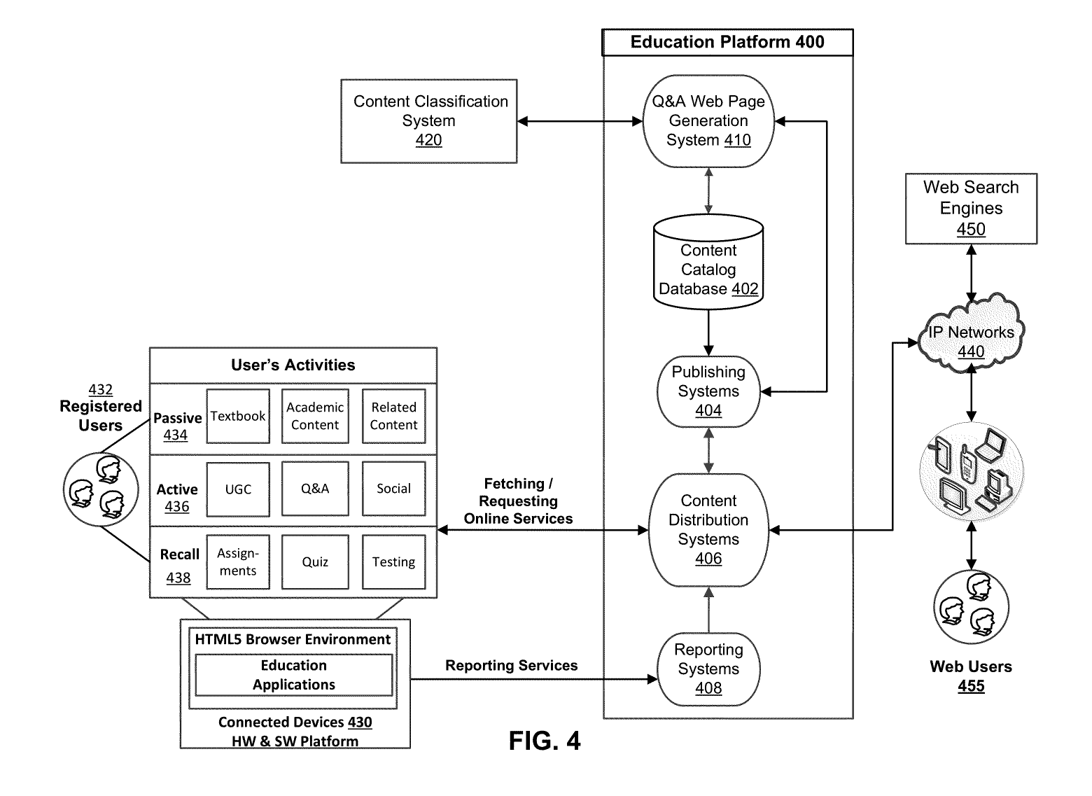

FIG. 4 illustrates an education publishing platform 400, according to one embodiment. As shown in FIG. 4, the education publishing platform 400 communicates with a content classification system 420, user devices 430, and one or more web search engines 450 via a network 440. The education platform 400 may have components in common with the functional blocks of the platform environment 100, and the HTML5 browser environment executing on the user devices 430 may be the same as the eReading application 170 of the experience block 104 of the platform environment 100 or the functionality may be implemented in different systems or modules.

The education platform 400 serves education services to registered users 432 based on a process of requesting and fetching on-line services in the context of authenticated on-line sessions. In the example illustrated in FIG. 4, the education platform 400 includes a content catalog database 402, publishing systems 404, content distribution systems 406, reporting systems 408, and a Q&A web page generation system 410. The content catalog database 402 contains the collection of content available via the education platform 402. In one embodiment, the content catalog database 402 includes a number of content entities, such as textbooks, courses, jobs, and videos. The content entities each include a set of documents of a similar type. For example, a textbooks content entity is a set of electronic textbooks or portions of textbooks. A courses content entity is a set of documents describing courses, such as course syllabi. A jobs content entity is a set of documents relating to jobs or job openings, such as descriptions of job openings. A videos content entity is a set of video transcripts. The content catalog database 402 may include numerous other content entities. Furthermore, custom content entities may be defined for a subset of users of the education platform 400, such as sets of documents associated with a particular topic, school, educational course, or professional organization. The documents associated with each content entity may be in a variety of different formats, such as plain text, HTML, JSON, XML, or others.

The content catalog database 402 feeds content to the publishing systems 404. The publishing systems 404 serve the content to registered users 432 via the content distribution system 406. The reporting systems 408 receive reports of user experience and user activities from the connected devices 430 operated by the registered users 432. This feedback is used by the content distribution systems 406 for managing the distribution of the content and for capturing user-generated content and other forms of user activities to add to the content catalog database 402. In one embodiment, the user-generated content is added to a user-generated content entity of the content catalog database 402.

Registered users 432 access the content distributed by the content distribution systems 406 via browser-based education applications executing on a user device 430. As users interact with content via the connected devices 430, the reporting systems 408 receive reports about various types of user activities, broadly categorized as passive activities 434, active activities 436, and recall activities 438. Passive activities 434 include registered users' passive interactions with published academic content materials, such as reading a textbook. These activities are defined as “passive” because they are typically orchestrated by each user around multiple online reading authenticated sessions when accessing the structured HTML referenced documents. By directly handling the fetching and requesting of all HTML course-based document pages for its registered users, the connected education platform analyzes the passive reading activities of registered users.

Activities are defined as “active” when registered users are interacting with academic documents by creating their own user-generated content layer as managed by the platform services. In contrast to “passive” activities, where content is predetermined and static, the process of creating user generated content is unique to each user, in terms of material, format, frequency, or structure, for example. User-generated content includes asking questions when help is needed and answering questions posted by other users. Other types of user-generated content include personal notes, highlights, and other comments, as well as interactions with other registered users 432 through the education platform 400 while accessing the referenced HTML documents. These user-generated content activities are authenticated through on-line “active” sessions that are processed and correlated by the platform content distribution system 406 and reporting system 408.

Recall activities 438 test registered users against knowledge acquired from their passive and active activities. In some cases, recall activities 438 are used by instructors of educational courses for evaluating the registered users in the course, such as through homework assignments, tests, quizzes, and the like. In other cases, users complete recall activities 438 to study information learned from their passive activities, for example by using flashcards, solving problems provided in a textbook or other course materials, or accessing textbook solutions. In contrast to the passive and active sessions, recall activities can be orchestrated around combined predetermined content material with user-generated content. For example, the assignments, quizzes, and other testing materials associated with a course and its curriculum are typically predefined and offered to registered users as structured documents that are enhanced once personal content is added into them. Typically, a set of predetermined questions, aggregated by the platform 400 into digital testing material, is a structured HTML document that is published either as a stand-alone document or as supplemental to a foundation document. By contrast, the individual answers to these questions are expressed as user-generated content in some testing-like activities. When registered users are answering questions as part of a recall activity, the resulting authenticated on-line sessions are processed and correlated by the platform content distribution 406 and reporting systems 408.

The question and answer web page generation system 410 generates web pages for questions asked by registered users 432 of the education platform 400 and answers to the questions. In one embodiment, the web page generation system 410 generates a web page for individual questions uploaded to the education platform 400. The web page is published at a public URL, making the question available to the registered users 432 as well as users not registered to the education platform 400.

A shown in FIG. 4, the education platform 400 is in communication with a content classification system 420. The content classification system 420 classifies content of the education platform 400 into a hierarchical taxonomy. The content classification system 420 may be a subsystem of the education platform 400, or may operate independently of the education platform 400. For example, the content classification system 420 may communicate with the education platform 400 over a network, such as the Internet.

The content classification system 420 classifies documents in the content catalog database 402. The content classification system 420 receives a set of taxonomic labels, which collectively define a hierarchical subject matter taxonomy. In the case of educational content, a hierarchical taxonomy may include labels for a plurality of disciplines and one or more subjects within each discipline. For example, art, engineering, history, and philosophy, are disciplines in the educational hierarchical taxonomy, and mechanical engineering, biomedical engineering, and electrical engineering are subjects within the engineering discipline. The taxonomic labels may include additional hierarchical levels, such as sub-subjects within each subject.

The content classification system 420 trains a model for assigning taxonomic labels to a representative content entity, which is a content entity determined to have a high degree of similarity to the other content entities of the catalog database 402 (e.g., textbooks). Using the model, the content classification system 420 assigns taxonomic labels to documents of other content entities, classifying the documents into the subject matter taxonomy. Thus, for example, the content classification system 420 uses the trained model to assign taxonomic labels to a question posted to the education platform 400, classifying the question into the subject matter taxonomy.

The web search engines 450 crawl web pages (including public web pages of the education platform 400) and index a title, URL, metadata description and keywords, and a breadcrumb of each web page to provide search results in response to user queries. The web search engines 450 apply a ranking algorithm to the indexed data to select search results relevant to a user's query and rank the search results. The web search engines 450 may be used by a wide variety of users, including users who are registered to the education platform 400 and users who are not registered to the education platform 400.

### Generating Search Engine-Optimized Web Pages

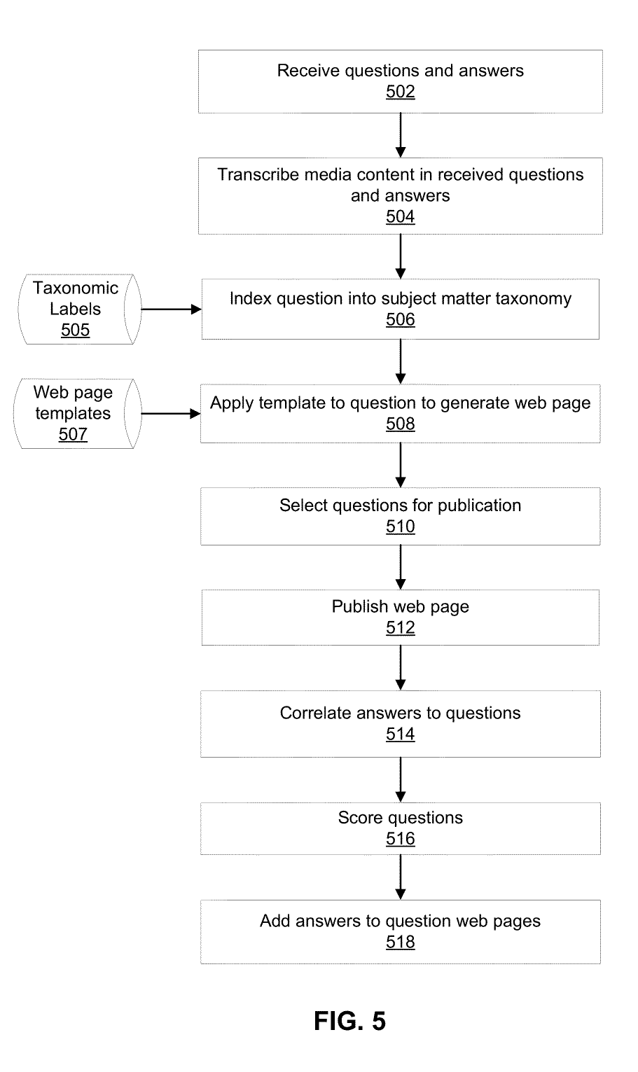

FIG. 5 is a flowchart illustrating a process for generating a search engine-optimized web page for question and answer content, according to one embodiment. In one embodiment, the process shown in FIG. 5 is performed by the web page generation system 410. Other embodiments of the process include fewer, additional, or different steps, and may perform the steps in different orders.

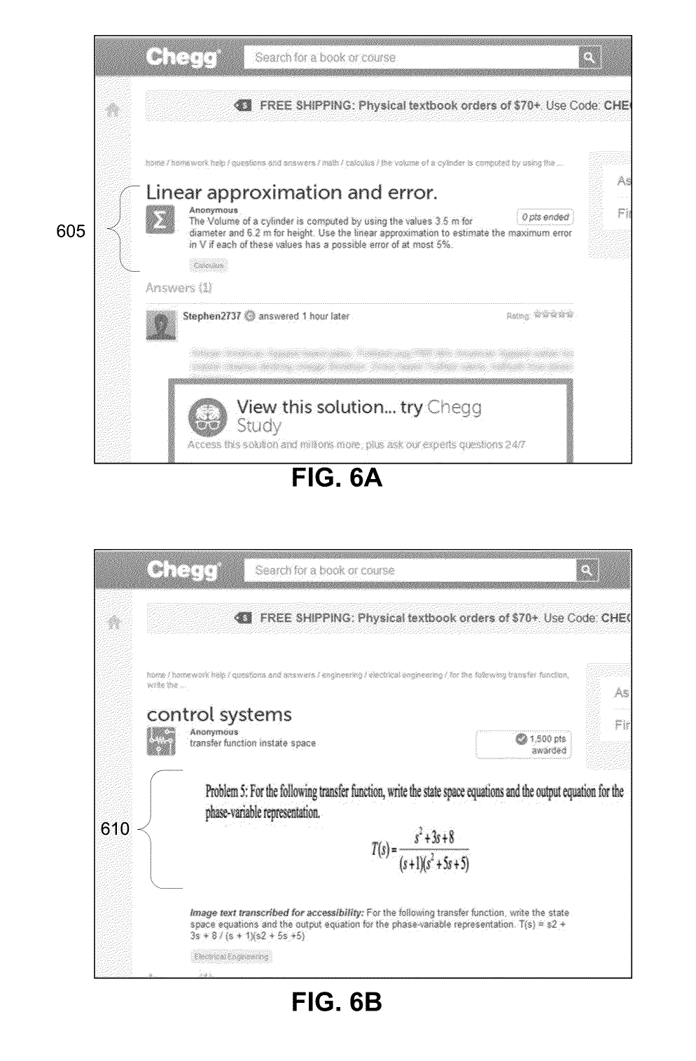

The web page generation system 410 receives 502 questions and answers uploaded to the education platform 400 by registered users of the platform. To upload a question, a user may type a question into an interface provided by the education platform 400 or upload a media file, such as an image, a voice recording, or a video. FIGS. 6A-B illustrate example questions received by the web page generation system 410. In FIG. 6A, a question includes text 605 entered by the user asking the question. In FIG. 6B, a question includes an image 610 captured by the user asking the question and uploaded to the education platform 400. Media content is a convenient and intuitive way for users to upload questions to the education platform 400. For example, it may be easier and faster for a user to capture a picture or video of a question or to record the user speaking the question than to type a question. Furthermore, a question including an image or a video may be clearer and more accurate than a typed question, as a user may mistype part of a typed question.

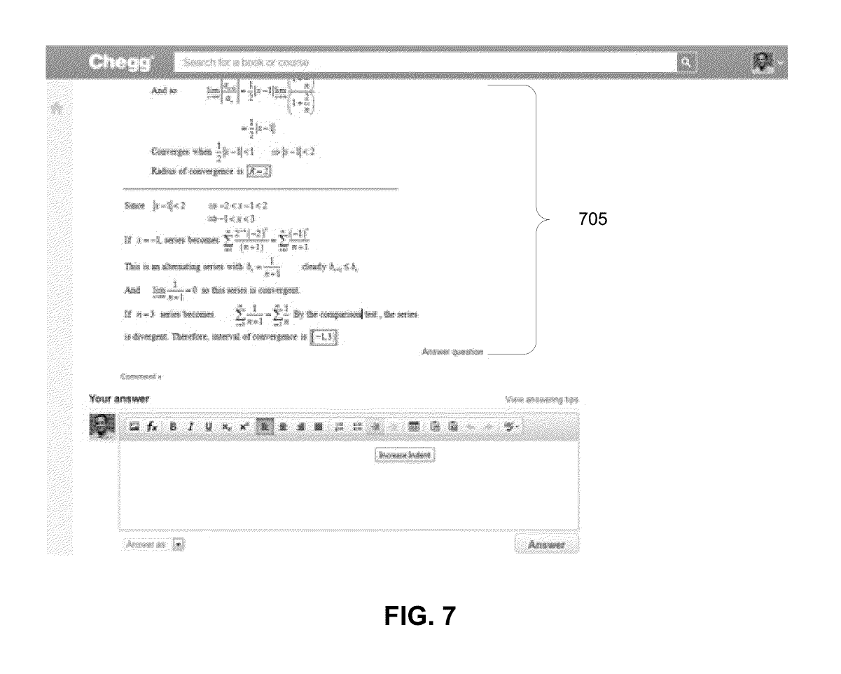

Users answering questions posted by other users may also input a textual answer or upload a media file to respond to a question. An example answer received by the web page generation system 410 is shown in FIG. 7. In FIG. 7, a user has entered text 705 to respond to a question posted by another user of the education platform 400. Alternatively, the answer content 705 may be an image uploaded by a user of the education platform 400 in response to the question. The questions and answers are received asynchronously at the web page generation system 410.

Returning to FIG. 5, the web page generation system 410 transcribes 504 media content in the received questions and answers. For example, the web page generation system 410 transcribes text included in uploaded images or videos into a plain text or HTML format (e.g., by optical character recognition), and transcribes verbal questions in videos or voice recordings into text (e.g., by a voice-to-text process). The web page generation system 410 may pre-process the media content to prepare it for transcription. For example, the web page generation system 410 normalizes images, adjusts image brightness, removes audio background noise, and detects and removes white space from audio recordings. In one embodiment, the web page generation system 410 applies a set of rules to transcribe media content. Example rules for transcribing images include omitting question numbering appearing in the image, transcribing formulas into text using only keys found on a regular keyboard (e.g., removing superscripts and subscripts), and replacing items that cannot be transcribed (e.g., diagrams, tables, graphs, or formulas that cannot be transcribed with only the keys found on a regular keyboard) with spaces. Example rules for transcribing video or audio include extracting a caption from a video or audio file, transcribing text and formulas contained with the caption, limiting the length of the transcription to a specified portion of the audio (e.g., 30 seconds), disregarding audio files containing multiple voices, removing specified language components (such as verbal fillers or profanity), and flagging non-English questions for manual processing. In another embodiment, the web page generation system 410 receives a manual transcription of a question or answer from an administrator of the education platform 400.

In one embodiment, the web page generation system 410 stores the transcribed text from multimedia content. The stored text is made available to a search engine internal to the education platform 400, which indexes the textual content. When a registered user searches the education platform 400, the indexed text enables the internal search engine to search questions and answers containing multimedia content and return the questions and answers as results for the user's search query.

For a question uploaded to the education platform 400, the web page generation system 410 indexes 506 the question into the subject matter taxonomy by applying one or more labels from a set 505 of taxonomic labels to the question. In one embodiment, the web page generation system 410 applies a trained model to features extracted from the question, such as a title of the question and the text of the question. The model assigns taxonomic labels to the question based on the extracted features. In one embodiment, the web page generation system 410 assigns each question a discipline label (e.g., mathematics) and a subject label (e.g., calculus).

The web page generation system 410 generates a web page for the question by applying 508 a template to the question. The web page generation system 410 stores a library 507 of web page templates, which include structured sections adapted to receive content of a question and generate various components of the web page. For example, the template applies an HTML structure to the question to prepare the question for web publication. In one embodiment, the template includes data fields for the content of the question, a web page title, a URL, a breadcrumb, a category, a metadata description, and metadata keywords. The page title may be a specified number of characters of the description of the question. The URL includes a domain name associated with the education platform 400 and a specified number of characters of the question description. The breadcrumb includes the taxonomic labels assigned to the question, as well as a portion of the question description. In one embodiment, the breadcrumb includes the full taxonomy of a question, clearly identifying the subject matter of the question. For example, if the education platform 400 assigns a question taxonomic labels for a discipline and a subject within the discipline, the breadcrumb identifies the discipline and the subject. The category section of the web page template includes the taxonomic classification of the question. The metadata description includes a portion of the question description, and is in the format “Answer to <first N characters of question description>.” The metadata keywords are generated by removing stop words from the metadata description and separating the resulting terms with commas.

The web page generation system 410 selects 510 a subset of the questions for publication. In one embodiment, the web page generation system 410 generates a quality metric for a question to determine whether to publish the question. The web page generation system 410 published the question if the quality metric of the question indicates the question is high quality, and does not publish the question if the quality metric indicates the question is low quality. In general, a question uploaded to the education platform 400 is low quality if it is non-descriptive or does not clearly define a problem. Indicators of a low-quality question include a short length and presence of certain keywords. In one embodiment, the web page generation system 410 trains a model for generating quality metrics for questions. The web page generation system 410 receives a training set of questions from an administrator, which are each assigned a quality metric (e.g., a binary value of “good” or “bad”). For example, the web page generation system 410 receives the following training set:

| Label | Title | Description |
|---|---|---|
| “Good” | “this is a linear algebra question” | “How can I do dot product |
| | | of two matrices” |
| “Bad” | “please help me” | “I will give points” |
| “Bad” | “help help help” | “urgent problem” |
| “Good” | “need help with chemistry | “please explain how to |
| | problem” | study molecular bonds” |

Using the training set, the web page generation system 410 trains a probabilistic classification model, such as a naïve Bayes model. The model applies a quality label to a question based on the title and description of the question. For example, the web page generation system 410 applies the model to the following question dataset:

| Title | Description |
|---|---|
| “I need help !!!!” | “now” |
| “I need help with math problems” | “help help !” |
| “need help with math” | “please calculate y = 2x + |
| | 3 for different values of x” |

When applied to the above dataset, for example, the model returns the quality labels “bad,” “bad,” and “good,” respectively.

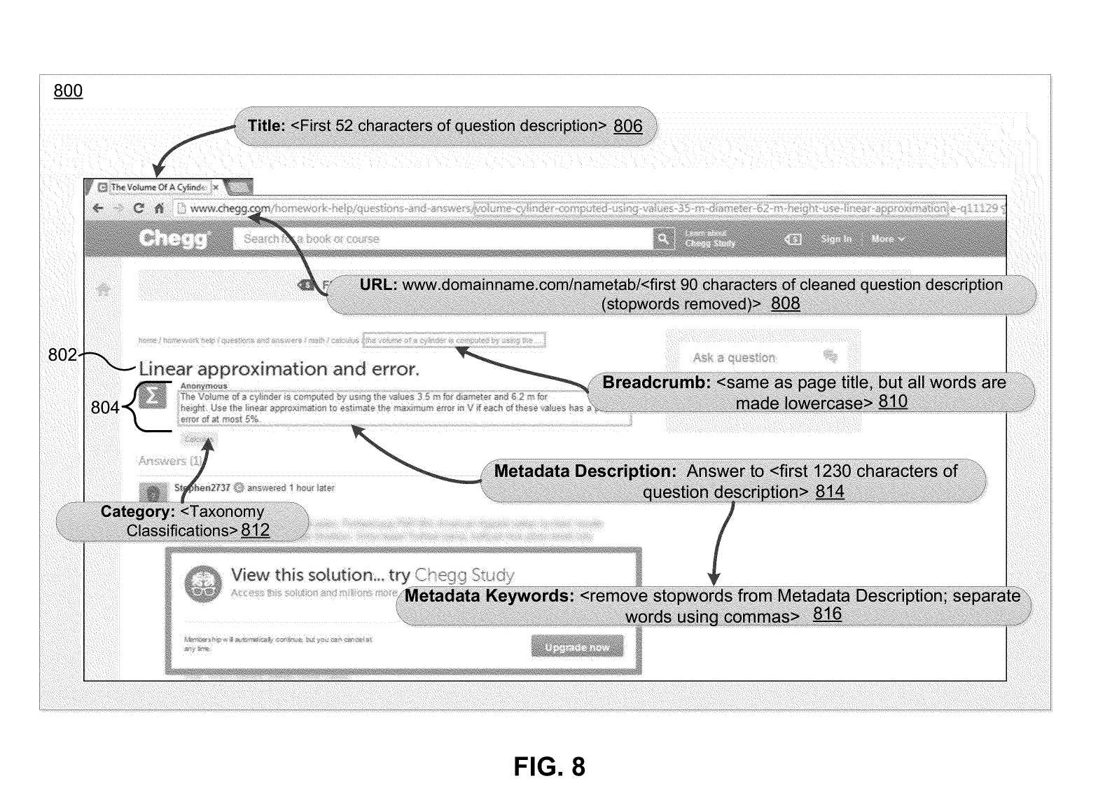

In one embodiment, the web page generation system 410 selects 510 the questions labeled as “good” for publication, and discards the questions labeled as “bad.” The web page generation system 410 publishes 512 the web pages corresponding to the selected questions. An example question web page 800 published by the web page generation system 410 is shown in FIG. 8. As shown in FIG. 8, the web page 800 includes a question title 802, a question description 804, a page title 806, a URL 808, a breadcrumb 810, a category 812, a metadata description 814, and metadata keywords 816. In the example shown, the page title 806 includes 52 characters of the question description 804, the URL includes 90 characters of the question description with stop words removed, and the breadcrumb 810 includes the same characters as the page title 806 except with any capital letters made lowercase. The category 812 includes at least one of the taxonomic labels assigned to the question. The metadata description 814 for the web page includes the phrase “Answer to” followed by 1230 characters of the question description 804, and the metadata keywords 816 include terms in the metadata description 814 separated by commas, with stop words removed. In other embodiments, the various sections of the web page 800 may include different portions of the question description 804, and may additionally or alternatively include a portion of the question title 802.

For an answer uploaded to the education platform 400, the web page generation system 410 correlates 514 the answer to a question. The web page generation system 410 scores 516 the answer based on a quality of the answer. In one embodiment, the web page generation system 410 scores 516 the answer based on properties of the answer content, such as the length of the answer, the use of terms such as “step 1,” “step 2,” and “step 3,” and whether the answer includes text, images, or a combination of text and images. For example, longer answers that include stepwise procedures are likely to be high-quality answers. Similarly, a combination of text and images in an answer is likely to be higher quality than an answer with only text or only images. For example, a graphical illustration of an answer may include annotations (such as arrows or stars) that would not be present in a text-only answer. As another example, in the case of answers involving mathematical steps, an image may be clearer to read or more accurate than typed equations.

The web page generation system 410 may also score 516 the answers based on properties of the user who uploaded the answer, such as a number of answers previously provided by the answerer, scores of the answerer's previous answers, whether the answerer has completed relevant coursework, or a grade point average of the answerer. In one embodiment, the web page generation system 410 applies a flat beta prior to the answer's score distribution to ensure the score assigned to a new answer is not inflated due to limited historical data. Furthermore, the user who uploaded the question may select an answer correlated to the question as a “best answer” to the question. In this case, the answer receiving the “best answer” designation receives a higher score than other answers to the question.

In one embodiment, the web page generation system 410 scores 516 an answer using a weighted sum of one or more of the properties of the answerer or the answer content. For example, the web page generation system 410 generates a weighted sum of the answerer's historical scores and the length of the answer as well as the binary scores of whether the question includes steps, whether the question includes both an image and text, and whether the answer was given a “best answer” designation. The answers may be ranked based on the assigned scores.

The web page generation system 410 adds 518 the answers matched to a question to the web page for the question. In one embodiment, if a plurality of answers are matched to one question, an order of the answers on the question's web page is based on the scores assigned to the answers. For example, the web page generation system 410 ranks the answers based on the assigned scores and places higher-ranked answers earlier on the web page than lower-ranked answers. In this case, when a new answer is received, the web page generation system 410 scores the new answer, ranks the new answer relative to previously-received answers based on the scores of each answer, and adds the new answer to the web page at a position based on the ranking

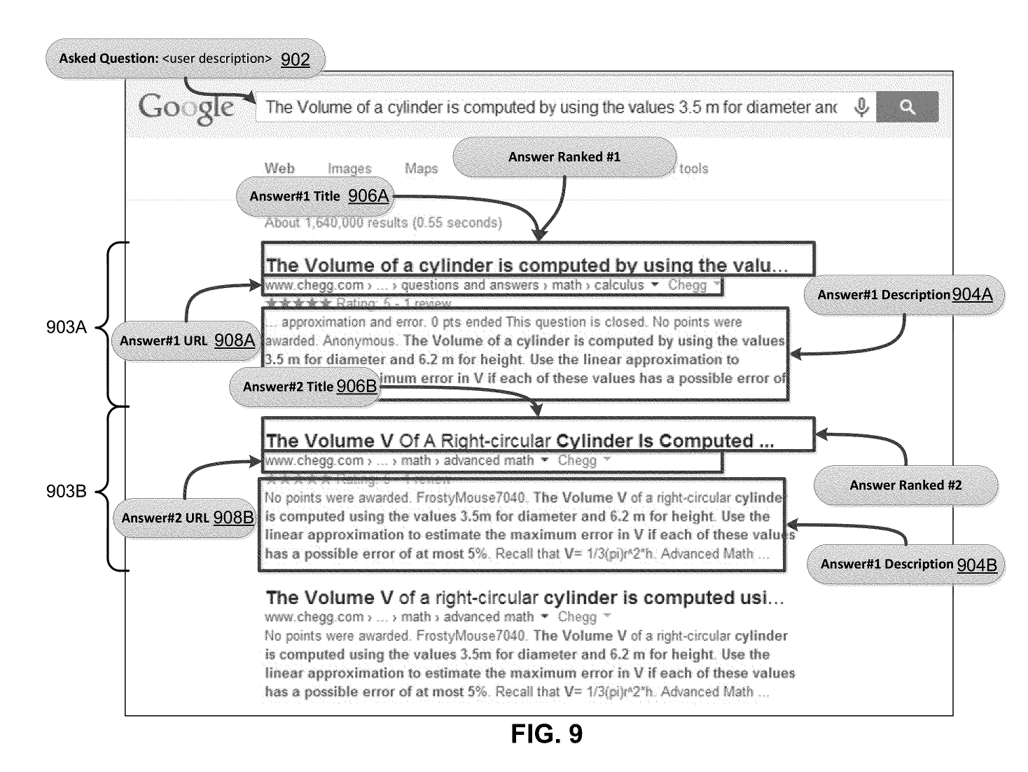

When the web search engines 450 index the web page published by the web page generation system 410, the web page template used to generate the published web page increases the page's ranking in search results. Thus, the question web pages may often be returned by the web search engines 450 as among the top results matching user queries for educational questions. FIG. 9 illustrates an example set of search results identified by a web search engine 450 in response to a user query 902. Two search result listings 903A and 903B are shown in FIG. 9. The search results 903 each include a portion of a questions description 904, a page title 906, and a URL 908.

Web pages generated by web page generation system 420 for publishing user-generated questions are structured to be ranked highly by the web search engines 450, even when the questions include media content. As users of the web search engines 450 often visit the highest ranked web pages for their search and do not visit lower-ranked web pages, increasing the rank of the question web pages improves the visibility of the question web pages (and therefore the education platform 400) to users of the web search engines 450. A higher ranking in the search results may therefore increase the visibility of questions to users of the search engines 450 who can answer the questions, increasing the probability that a question is answered and thereby improving the usefulness of the education platform 400 to users who ask questions. Furthermore, a higher ranking in the search results may drive users of the web search engines 450 who are not registered users of the education platform 400 to visit content and services provided by the education platform 400.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML or HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for generating search engine-optimized web pages for question and answer content, the method comprising:
receiving at an online system, a question generated by a user of the online system, content of the question comprising media content;
transcribing the media content of the question;
applying a web page template to the question content to generate a web page, the web page template including a metadata description, a breadcrumb, and a uniform resource locator, at least one of the metadata description, the breadcrumb, and the uniform resource locator comprising a portion of the transcribed media content of the question; and
publishing the web page at a location specified by the uniform resource locator.

2. The method of claim 1, wherein the media content comprises at least one of an image, a voice recording, and a video.

3. The method of claim 1, further comprising:
classifying the question into a hierarchical subject matter taxonomy;
wherein the breadcrumb further comprises the classification of the question.

4. The method of claim 3, wherein the subject matter taxonomy classifies content of the online system into a hierarchy of a plurality of disciplines and one or more subjects within each discipline, and wherein classifying the question into the subject matter taxonomy comprises:
identifying a discipline and a subject with which the question is associated;
wherein the breadcrumb includes the discipline and the subject of the question.

5. The method of claim 1, wherein the template further includes a page title comprising a fourth portion of the transcribed media content of the question and metadata keywords comprising one or more terms from the metadata description.

6. The method of claim 1, further comprising:
generating a quality metric for the question using a trained probabilistic classifier;
wherein the web page is published responsive to the quality metric indicating the question is high quality.

7. The method of claim 1, further comprising:
receiving an answer to the question at the online system; and
adding the answer to the published web page.

8. The method of claim 1, further comprising:
receiving from a plurality of users of the online system, a plurality of answers to the question;
ranking the plurality of answers based on properties of each answer and properties of a user uploading each answer to the online system; and
adding the plurality of answers to the published web page, wherein a higher ranked answer is displayed on the published web page above a lower ranked answer.

9. The method of claim 8, wherein each of the answers comprises at least one of text and an image, and wherein an answer including both text and an image is ranked higher than an answer not including an image.

10. The method of claim 8, further comprising:
receiving another answer to the question after the plurality of answers;
ranking the other answer relative to the plurality of answers; and
adding the other answer to the published web page, a position of the other answer on the published web page based on the ranking of the other answer relative to the plurality of answers.

11. A non-transitory computer-readable storage medium storing computer program instructions, the computer program instructions when executed by a processor causing the processor to:
receive at an online system, a question generated by a user of the online system, content of the question comprising media content;
transcribe the media content of the question;
apply a web page template to the question content to generate a web page, the web page template including a metadata description, a breadcrumb, and a uniform resource locator, at least one of the metadata description and the breadcrumb comprising a portion of the transcribed media content of the question; and
publish the web page at a location specified by the uniform resource locator of the published web page including a third portion of the transcribed media content of the question.

12. The non-transitory computer-readable storage medium of claim 11, wherein the media content comprises at least one of an image, a voice recording, and a video.

13. The non-transitory computer-readable storage medium of claim 11, further comprising computer program instructions that when executed by the processor cause the processor to:
classify the question into a hierarchical subject matter taxonomy;
wherein the breadcrumb further comprises the classification of the question.

14. The non-transitory computer-readable storage medium of claim 11, wherein the subject matter taxonomy classifies content of the online system into a hierarchy of a plurality of disciplines and one or more subjects within each discipline, and wherein the computer program instructions causing the processor to classify the question into the subject matter taxonomy comprise computer program instructions that when executed by the processor cause the processor to:
identify a discipline and a subject with which the question is associated;
wherein the breadcrumb includes the discipline and the subject of the question.

15. The non-transitory computer-readable storage medium of claim 11, wherein the template further includes a page title comprising a fourth portion of the transcribed media content of the question and metadata keywords comprising one or more terms from the metadata description.

16. The non-transitory computer-readable storage medium of claim 11, further comprising computer program instructions that when executed by the processor cause the processor to:
generate a quality metric for the question using a trained probabilistic classifier;
wherein the web page is published responsive to the quality metric indicating the question is high quality.

17. The non-transitory computer-readable storage medium of claim 11, further comprising computer program instructions that when executed by the processor cause the processor to:
receive an answer to the question at the online system; and
adding the answer to the published web page.

18. The non-transitory computer-readable storage medium of claim 11, further comprising computer program instructions that when executed by the processor cause the processor to:
receive from a plurality of users of the online system, a plurality of answers to the question;
rank the plurality of answers based on properties of each answer and properties of a user uploading each answer to the online system; and
add the plurality of answers to the published web page, wherein a higher ranked answer is displayed on the published web page above a lower ranked answer.

19. The non-transitory computer-readable storage medium of claim 18, wherein each of the answers comprises at least one of text and an image, and wherein an answer including both text and an image is ranked higher than an answer not including an image.

20. The non-transitory computer-readable storage medium of claim 18, further comprising computer program instructions that when executed by the processor cause the processor to:
receiving another answer to the question after the plurality of answers;
ranking the other answer relative to the plurality of answers; and
adding the other answer to the published web page, a position of the other answer on the published web page based on the ranking of the other answer relative to the plurality of answers.
